(19) United States
(12) Patent Application Publication
(10) Pub. No.: US 2014/0279598 A1
(43) Pub. Date: Sep. 18, 2014

(54) SYSTEMS AND METHODS FOR AUTOMATING COLLECTION OF INFORMATION

(71) Applicant: DESIRE2LEARN INCORPORATED, Kitchener (CA)

(72) Inventor: Kenneth CHAPMAN, Kitchener (CA)

(73) Assignee: DESIRE2LEARN INCORPORATED, Kitchener (CA)

(21) Appl. No.: 13/832,553

(22) Filed: Mar. 15, 2013

(51) Int. Cl. G06Q 30/00

(52) U.S. Cl. CPC G06Q 30/018
USPC 705/317

(57) ABSTRACT

The disclosure is directed at system and method of automating collection of information. More specifically, a method of collecting submission information in an academic institution including developing a common language for all information within the academic institution; identifying the submission information for submission to accreditation board; retrieving the submission information; and transmitting the submission information to the accreditation board is provided.

### FIELD

The disclosure is directed generally at managing information and more specifically at systems and methods for automating collection of information, such as accreditation requirements.

### BACKGROUND

Currently within many organizations or institutions, such as academic institutions, in order to be recognized as an accredited entity, the organization or institution (herein referred to as “institution”) is required to submit documentation which reflects mastery or adherence to specific criteria as required by an accreditation board. This criteria may include the compliance of the institution or a program within the institution with standards for specific outcomes, quality control of the institution or program or other factors important to the accreditation board.

For many institutions, this is an extremely arduous task involving a considerable amount of coordination, manual work, reporting and communication. This accreditation process may involve information or input from various departments within the institution and may be stored in separate locations. To collect all of the information from each department may be time consuming and there may be a duplication of information provided.

The duplication of information may be due to the fact that different departments have different identifiers for similar information. For instance, one department may refer to a list of students as a roster of students while another department may refer to the same list of students as a class list. In some cases, with differing nomenclature, there is a likelihood that the same list may be submitted by separate departments to the accreditation board. Alternatively, there is a requirement for an designated individual to manually review all the documents prior to its submission to the accreditation board.

Therefore, there is provided a system and method for automating collection of information, such as accreditation requirements.

The above information is presented as background information only to assist with an understanding of the present disclosure. No determination has been made, and no assertion is made, as to whether any of the above might be applicable as prior art with regard to the present disclosure.

### SUMMARY

It is an object of the present disclosure to obviate or mitigate at least one disadvantage of previous systems and methods for automating collection of information, such as accreditation requirements.

In one aspect, there is provided a method of collecting submission information in an academic institution including developing a common language for all information within the academic institution; identifying the submission information for submission to accreditation board; retrieving the submission information; and transmitting the submission information to the accreditation board.

In another aspect, developing a common language includes reviewing accreditation board requirements; and creating list of designations for use in the common language based on the accreditation board requirements.

In yet another aspect, developing a common language also includes determining a list of synonyms between list of designations and the information within the academic institution; and selecting an entry from the list of synonyms to represent all information of that type.

Another aspect of the disclosure is that developing a common language further includes aligning terminology describing information of that type with the selected entry.

Another aspect is directed at wherein aligning terminology includes re-naming all previous stored information of that type with the selected entry. A further aspect is directed at wherein aligning terminology includes naming all new information of that type with the selected entry.

In another aspect, identifying submission information includes reviewing the accreditation board requirements; selecting submission information relating to the accreditation board requirements; and determining if the accreditation board requirements has been met by the submission information.

In yet a further aspect, identifying submission information includes receiving request to retrieve submission information based on selected criteria. In yet another aspect, the selected criteria is based on accreditation board requirements.

A further aspect of the disclosure provides that the selected criteria is based on the common language.

In another aspect, retrieving submission information includes searching a database for all information associated with accreditation board requirements. In yet another aspect, retrieving submission information includes searching a database to determine all information associated with at least one entry in the list of synonyms; and retrieving all information determined to be associated with at least one entry in the list of synonyms.

In another aspect, there is provided a system for automating collection of information in a teaching environment having at least one database storing the information; a processor for receiving a request for submission information and for retrieving submission information based on accreditation board requirements from the at least one database; wherein the information stored in the database and the accreditation board requirements are aligned with a common language.

In a further aspect, the system further has an external interface for communicating with a user.

In yet a further aspect, the processor transmits the retrieved submission information to a designated entity. In another aspect, the designated entity is a user or an accreditation board.

In yet another aspect, there is provided a computer program product comprising a computer readable memory storing computer executable instructions thereon that when executed by a computer to develop a common language for all information within the academic institution; identify the submission information for submission to accreditation board; retrieve the submission information; and transmit the submission information to the accreditation board.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a schematic diagram of a search framework according to an embodiment;

FIG. 2 is a flowchart outlining a method of automating collection of information in an embodiment; and

FIG. 3 is a schematic diagram of apparatus for automating collection of information in an embodiment.

Throughout the drawings, it should be noted that like reference numbers are used to depict the same or similar elements, features, and structures.

### DETAILED DESCRIPTION

Generally, the present disclosure provides systems and methods for automating collection of information, such as accreditation requirements.

In order to receive accreditation from accreditation boards, applicants, such as the institutions or departments within an institution, are required to show mastery in predetermined criteria as set out by the accreditation board in order to be accredited. The applicant may show that they meet the standards of the accreditation board by submitting information or documents relating to the requirements which reveal mastery or documents reflecting that the institution has met the standards set out by the accreditation board.

As in many organizations or institutions, further labeled as institutions in the current specification, there is generally a need to submit a large number of documents or evidence to the accreditation board for the review and approval process. In many of these institutions, the required information is not stored in a single location but is stored in different departments, locations, servers or even filing cabinets across the institution. In order to overcome this, one solution may be to store all of the information in a single location, preferably in digital format in a single server or using cloud computing or architectures. It may also be beneficial to generate a common language or nomenclature for the information between each of the different departments in order to avoid supplying duplicate entries of information to the accreditation board.

Typically, all of the information to be submitted is collected and reviewed by at least one individual who may serve as the person who puts the entire submission together. In some scenarios, the mere collection of all this information may cause the individual to review multiple copies of the same document which may be due to different naming conventions between departments. This may result in a delay in the submission or may be more time consuming for the individual to complete the task. In an embodiment of the disclosure, the system aims to create a common language, or nomenclature between the different departments and the requirements of the accreditation board so that the collected information may be quickly reviewed and the number of duplicates may be reduced or eliminated. Along with the common nomenclature, there is a benefit for each of the documents to be stored in a single repository such as a single server. This also allow for retrieval of the documents to be easier. In an embodiment, the system aligns the nomenclature for like documents of each of the departments with that of the accreditation board in order to benefit from a more streamlined naming convention.

Another advantage of the system is that the content and curriculum or courses may be aligned around outcomes required by the accreditation board. BY understanding the requirements of the accreditation board, departments seeking accreditation may design their courses to meet these requirements. Furthermore, processes and workflow(s) may be managed to collect and expose data necessary to meet the accreditation board requirements. The system may also provide easy access to information such as, but not limited to, course materials, student progress and other artifacts to backup aggregate data. In this manner, comprehensive reports may be easily generated for each level of the institution or program within the institution.

While the current disclosure is directed at accreditation for institutions, more specifically academic institutions, the disclosed method, apparatus and system may also be considered for other environments.

Therefore, in an embodiment of the disclosure, there is a need to produce a common language between the requirements of the accreditation board and the information which is being stored by the institution. For instance, the accreditation board may require that the institution or a department within the institution have five tests and ten homework assignments during one course before the course is recognized by the accreditation board. If the academic institution refers to tests, while the accreditation board recognizes all examples of testing as quizzes, an individual would be required to change the nomenclature designation of all the tests within the academic institution to quizzes in order to facilitate the collection of quizzes to satisfy the accreditation board. If the academic institution already designates the quizzes as tests, there is no need for a change in the nomenclature of the information for submission.

Therefore, in order to implement the current disclosure, there is a need to understand the requirements by which the accreditation board is reviewing an institution with respect to providing a accreditation for the institution or a department within the institution.

Turning to FIG. 1, a schematic diagram of a search framework for use in a teaching environment, or a teaching environment search framework, is shown. The teaching environment search framework 10 may also be seen as layout of an institution, preferably academic, and the information stored within the institution which may be submitted to the accreditation board. The teaching environment search framework 10 is a schematic structure of a hierarchy which may provide a structure for different levels of the teaching environment. Each circle within the search framework may be seen as one of the OrgUnits. For instance, in the example of FIG. 1, the levels of the teaching environment include an organization level 12 including a University 14, a Department level 16 including a Math department 18 and a Chemistry department 20 and a Course level 22 including a Calculus 101 course 24, a Statistics 200 course 26, an Inorganic Chemistry course 28 and an Organic Chemistry course 30. The overall search framework may be seen as a tree. In another embodiment, within a single search framework may be multiple organizations, or trees, however, only one is shown for simplicity in FIG. 1.

As shown in FIG. 1, the Math department 18 and the Chemistry department 20 on the department level 16 are associated with the University 14 while the Calculus 101 course 24 and Statistics 200 course 26 on the Course level 22 are associated with the Math department 18 and the Inorganic Chemistry course 28 and the Organic Chemistry course 30 are associated with the Chemistry department 20. Although not shown, there may also be other departments and associated courses and there is no limit to the size of the teaching environment search framework.

Associated with each of the OrgUnits of the teaching environment search framework are individual pieces of information, or user content 32, which may be retrieved by individuals collecting information for the submission to the accreditation board. The relationship between a piece of user content 32 and an OrgUnit is reflected by the dotted line. With respect to user content, examples include, but are not limited to, test, quizzes, class notes, exams, prior exams, professor rating forms or class marks.

Turning to FIG. 2, a flowchart outlining a method of automating collection of information, or user content, is shown. Initially, in order to facilitate the collection of information, a common language or nomenclature is developed at step 100. In other words, a review of the terminology used to describe all of the user content is reviewed and a common language developed so that all of the user content is designated using a single naming convention. If this method is being used in the collection of accreditation information, a review of the requirements of the accreditation board is performed and then the terminology for all of the user content stored within the search framework is updated to reflect or be parallel with the terminology of the accreditation board. Therefore, when it is time to collect the information for the accreditation board, simple key word searches may be performed to obtain all information in the search framework associated with the required information. In a more specific example, if the accreditation board requires a copy of all tests which are given in a specific course, the system would update all of the user content in the search framework which involves testing the proficiency of a student within the course as tests. Alternatively, this naming convention may be implemented before the information is stored in the search framework. In other words, user content which may be designated as exams, quizzes and mid-terms would be re-designated as tests in order to more easily retrieve the requested accreditation information when required.

In an embodiment, the development of the common language allows for specific outcomes that the accreditation board is looking for, in the form of accreditation board requirements, to be regularly monitored. For instance, the common language may be designed to include language such as, but not limited to, five assignments required or ten article readings assigned. The meeting of these criteria may then be stored in the system as a type of information so that rather than needing to submit evidence of each assignment, a single piece of user content indicating that five assignments were assigned meets the requirements of the accreditation board.

In an embodiment, the common language is performed by reviewing accreditation board requirements; and creating list of designations for use in the common language based on the accreditation board requirements. The list of designation may include specific outcomes or the meeting of accreditation board requirements that the accreditation board is looking for. The development of the common language may further include determining a list of synonyms between the list of designations and the information stored within the system and then selecting an entry from the list of synonyms to represent all information of that type such as disclosed above.

As the common language is being developed, the information for submission is collected at step 102. This information may be collected concurrent to the development of the common language or after the common language has been developed. By designating all of the user content with the common language, the collection of information may be enhanced and more regulated and improved. For instance, with the common language, searching for the submission information may be made easier since there may only be a need to perform a single search for all tests within the search framework. For all new user content which is stored after the common language is developed, the naming of this new user content is straight forward. For all the user content previous stored in the search framework, the updating of the terminology describing the user content needs to be updated to reflect the common language.

When it is determined that there is need for a submission to the accreditation board, a review of the all of the user content is performed and an identification of the user content for collection and submission is identified at step 104 and may be seen as a step of identifying submission information. In other words, this may include a review of the requirements of the accreditation board in relation to the information that is available within the search framework.

After identifying the submission information, the submission information, in the form of the individual pieces of user content, is then collected, or retrieved at step 106 for the accreditation board. This may be performed by doing a search within the search framework of all user content which matches with the requirements of the accreditation board. For instance, if the accreditation board requires all of tests in the Calculus 101 course 24, the system may perform a search using a specific keyword (as determined by the common language), of all the user content associated with the Calculus 101 course 24 associated with the keyword. If the system includes user content which reflects compliance of accreditation board requirement, this user content may be included in the submission information rather than the individual pieces of user content reflecting compliance of the requirements. In other words, if an accreditation board requirement is that five assignments be assigned in a course, a single piece of user content can be submitted showing that five assignments were assigned rather than copies of each of the five assignments.

After the submission information is collected, it may then be transmitted at step 108 to either the accreditation board or an individual which oversees the process who may then pass on the collected information to the relevant parties, such as the accreditation board.

As described in more detail below, the method may also include a regular monitoring of completion of accreditation board requirements at step 110, however this would be executed concurrent with the flowchart of FIG. 2. If the processor has the accreditation board requirements pre-stored (such as a part of the common language), mastery or compliance of these requirements may be regularly recorded or tracked as new information is stored within the search framework or teaching environment. Therefore, as described briefly above, the submission information may include the user content showing compliance of certain requirements rather than the individual user content associated with the compliance of the requirements. In order words, the processor may serve as an internal monitor for the meeting of accreditation board requirements by continuously comparing information stored with these requirements. For instance, if there is a need for ten quizzes in a specific course, the processor may include a counter for each time a quiz or test or the like is stored and associated with the specific course and when the counter equals ten, the processor can confirm mastery or completion of this accreditation board requirement by marking it off in a list or database or something similar. Therefore a quick review by an individual from the institution or the accreditation board may provide a regular update as to compliance to accreditation board requirements. Alternatively, each time new information is stored which is associated with an accreditation board requirement, an indication of the entry of this new information may be transmitted to a user so that the user may monitor the mastery or completion of accreditation board requirements.

Turning to FIG. 3, a schematic diagram of a system for automating collection of information. The system 40 includes a central processing unit 42 which is connected to a set of databases 44 which may store the information which is required for automated collection. As would be understood, there may be only one database which stores all of this information. For instance, if the system is associated with an academic institution, the information, typically in the form of user content, may relate to user content relating to accreditation requirements for an accreditation board to assess a department within, or even the entire academic institution. A user, or accreditation board, may access the system via an external interface 46.

In an embodiment, within the processor 42 is a set of modules which may perform the steps of identifying submission information, collecting submission information and transmitting submission information when instruction to do so. In this embodiment, the processor 42 may either have pre-stored instructions for identifying the submission information required or may be provided with the instructions for the type of user content to collect or retrieve.

For use in an academic institution, each database may represent a separate department within the academic institution.

In another embodiment of the disclosure when used in the academic institution, it is beneficial to align the content and curriculum of the individual courses to align or comply with requirements for the accreditation board. For instance, if it is known that the accreditation board requires each course to issue 10 assignments and 3 tests over a four month period, the course may be designed to meet these minimum requirements.

In another embodiment of the disclosure, it is beneficial to allow the processor to manage the processes and workflow for collecting the submission information. For instance, if the user wishes to retrieve all user content in a department or the institution relating to exams, quizzes or tests, which may be collectively termed as tests via the common language, the process may simply retrieve all user content which includes the word test in its description or title from within the search framework. The collection of this information may be simplified and may not have to be verified by a third party, or a human being, as it is assumed that the user content within the search framework has been designated properly.

In order to maintain a search framework which includes properly designated user content or that certain milestones are being met, the processor may perform scheduled checks to sample evidence of the user content relating to specific courses to monitor student progress, or other artifacts to backup aggregate data.

Finally, by improving the automated collection of user content and by being able to simplify this process comprehensive reports may be generated at different levels, such as the course level or the department level or any other levels within the search framework.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method of collecting submission information in an academic institution comprising:
developing a common language for all information within the academic institution;
identifying the submission information for submission to accreditation board;
retrieving the submission information; and
transmitting the submission information to the accreditation board.

2. The method of claim 1 wherein developing a common language comprises:
reviewing accreditation board requirements; and
creating list of designations for use in the common language based on the accreditation board requirements.

3. The method of claim 2 wherein developing a common language comprises:
determining a list of synonyms between list of designations and the information within the academic institution; and
selecting an entry from the list of synonyms to represent all information of that type.

4. The method of claim 3 wherein developing a common language further comprises:
aligning terminology describing information of that type with the selected entry.

5. The method of claim 4 wherein aligning terminology comprises:
re-naming all previous stored information of that type with the selected entry.

6. The method of claim 4 wherein aligning terminology comprises:
naming all new information of that type with the selected entry.

7. The method of claim 1 wherein identifying submission information comprises:
reviewing the accreditation board requirements;
selecting submission information relating to the accreditation board requirements; and
determining if the accreditation board requirements has been met by the submission information.

8. The method of claim 1 wherein identifying submission information comprises:
receiving request to retrieve submission information based on selected criteria.

9. The method of claim 8 wherein the selected criteria is based on accreditation board requirements.

10. The method of claim 9 wherein the selected criteria is based on the common language.

11. The method of claim 1 wherein retrieving submission information comprises:
searching a database for all information associated with accreditation board requirements.

12. The method of claim 4 wherein retrieving submission information comprises:
searching a database to determine all information associated with at least one entry in the list of synonyms; and
retrieving all information determined to be associated with at least one entry in the list of synonyms.

13. A system for automating collection of information in a teaching environment comprising:
at least one database storing the information;
a processor for receiving a request for submission information and for retrieving submission information based on accreditation board requirements from the at least one database;
wherein the information stored in the database and the accreditation board requirements are aligned with a common language.

14. The system of claim 13 further comprising an external interface for communicating with a user.

15. The system of claim 13 wherein the processor further transmits the retrieved submission information to a designated entity.

16. The system of claim 15 wherein the designated entity is a user or an accreditation board.

17. A computer program product comprising a computer readable memory storing computer executable instructions thereon that when executed by a computer to perform the method steps of claim 1.
